(19) United States
(12) Patent Application Publication
(10) Pub. No.: US 2014/0224808 A1
(43) Pub. Date: Aug. 14, 2014

(54) Apparatus for retarding oxidation of leftover paint in a storage container

(71) Applicant: Jean Ronald Brisard, Englewood, NJ (US)

(72) Inventor: Jean Ronald Brisard, Englewood, NJ (US)

(21) Appl. No.: 13/763,589

(22) Filed: Feb. 8, 2013

(51) Int. Cl. B44D 3/12; B65B 31/00; B65B 3/04

(52) U.S. Cl. CPC B44D 3/12; B65B 3/04; B65B 31/00
USPC 220/495.02; 53/459

(57) ABSTRACT

An apparatus for retarding oxidation of paint that only partly fills a container, comprising a body, a flexible liner, a movable bottom plate, an attachable lid with a filler port through which the paint can be poured, and a removable filler cap. The movable bottom plate is adjusted up or down, thereby expanding or compressing the flexible liner and changing the volume of the container. After paint is added to the container, excess air is forced out of the container via the filler port by moving the bottom plate up towards the top of the container. When all extra air is expelled, the movable bottom plate is locked into position and the filler port is closed with the removable filler cap. Using this device allows paint to be stored in an air-free environment, reducing oxidation and resulting in greatly improving the shelf life of the stored paint.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates the storage of leftover paint and more specifically to a variable capacity container for storing paint in an air-free environment. In particular, the invention concerns an apparatus and methods for retarding oxidation of paint that only partly fills a container that is formed with a body, a lid with a filler port and a movable bottom.

In a perfect world, a painter would know exactly how much paint is needed for a specific job and the paint retailer would sell the exact needed amount. In the real scenario, the needed paint is estimated and then purchased in multiple sizes of containers, namely, quart-size, gallon-size or five-gallon size containers. Invariably there will be some leftover paint, possibly of different color and specification. This extra paint usually ends up being stored in the original paint cans and placed in on a shelf in the basement or a garage, only to be found unusable when needed for touch-ups because after some time in storage, the paint hardens, dries out or otherwise deteriorate. The degradation of the paint occurs because anytime an air-curable liquid is stored in a container where air is present, the chemical process of oxidation will cause the gradual curing and subsequent degradation of the paint or liquid. It is also a known fact that extreme heat or cold temperature hastens the degradation of paint while in storage.

The problem of stored paint degradation due to improper storage has been recognized for some time. The prior art disclose numerous devices providing a means of storing paint in an air-free environment. For example, the prior art disclose the use of a vapor barrier, disclosed in U.S. Pat. No. 925,447 to Gunderson. The membrane of the vapor barrier is laid on top of the paint to create a seal inside the paint can. Another device is disclosed in U.S. patent application Ser. No. 09/643,425 to Alvarez that uses a series of quart bottles to store leftover paint.

In analyzing the prior art, many shortcomings are evident in the efficacy of the methods used to store and access the leftover paint. In the disclosure of U.S. Pat. No. 925,447 to Gunderson, the membrane of the vapor barrier must fit perfectly along the perimeter of the container in order to create an effective seal between the paint and the surrounding air. In addition, the issue of the space management in storing partially filled cans of paint is not addressed. In the device disclosed in U.S. patent application Ser. No. 09/643,425 to Alvarez, the stored paint could be potentially exposed to ambient air if the bottle is not completely full. This would result in the premature degradation of the stored paint.

The current invention makes significant improvements over those disclosed in the prior art by providing an efficient and convenient way to store variable quantities of leftover paint while using one easily adjustable container. Furthermore, the removal of excess air in the container is achieved by simply adjusting the movable bottom plate and expelling the air out of the filler port located in the lid of the container. Moreover, the present invention provides a convenient way to dispense the stored paint by adjusting the movable bottom and forcing the paint to flow out of the filler port located in the lid of the container.

### BRIEF SUMMARY OF THE INVENTION

Accordingly, the primary object of the present invention is to provide an apparatus and method for retarding oxidation of paint and other liquid stored in a partly filled container.

Another object of the present invention is to provide a convenient and efficient way to store variable quantities of leftover paint by using an easily adjustable variable capacity container.

Another object of the present invention is to provide an easily adjustable variable capacity container that inhibits or retards the oxidation of paint or other liquids by removing the excess air in the storage container.

A further object of the present invention is to provide an easily adjustable variable capacity container that prevents stored paint from oxidizing, drying, separating and otherwise decomposing while in storage.

Yet another object of the present invention is to provide an efficient and convenient means of storing left-over paint in a compact, clean and easily identifiable container.

Still yet another object of the present invention is to provide an effective and simple means to easily view and identify the stored paint.

Another object of the present invention is to provide a paint storage device with an easy and efficient paint dispensing attachment.

Another object of the present invention is to provide a paint storage device with an easy and efficient paint applicator attachment.

A further object of the invention is to provide a paint storage device that can be easily stored in a convenient, compact and temperature-controlled storage bin, thereby further increasing the shelf life of the stored paint or other liquid.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, the foregoing and related objects of the invention are attained by the provision for apparatus for retarding oxidation of a liquid that only partly fills a container formed with a lid with a filler port through which said liquid can be poured comprising: a container having a body with an upper section with an open end and an orifice, an attachable lid with a filler port and a removable filler cap, a flexible liner suspendable from the open end of the body so as to form a chamber within the body, a bottom section with a movable plate with means lock the bottom plate and means to move said bottom plate up and down in said body, thereby changing the volume of the container.

Certain of the foregoing and related objects are readily available in said apparatus whereas moving the bottom plate up towards the upper end of said container results in expelling all excess air out of the partly filled container through the open filler port.

Certain of the foregoing and related objects are readily available in said apparatus whereas moving the bottom plate up towards the upper end of said container results in the dispensing the stored paint out of the container through said removable dispensing attachment.

Certain of the foregoing and related objects are readily available in said apparatus, whereas said bottom plate is adjusted up towards the upper end of said container, thereby dispensing the stored paint out of the container through said removable paint applicator attachment.

Certain of the foregoing and related objects are readily available in said apparatus, whereas the movable bottom plate of said container is moved by means mediated by the expanding action of an inflatable bladder, whereby said bladder is inflated by a pump, resulting in moving the bottom plate and changing the volume of said container.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a cross sectional view of the invention.

FIG. 3 is a side view of the invention.

FIG. 4 is a cross sectional view of the movable plate and handle section of the invention.

FIG. 5 is a perspective view of the invention with the removable paint dispenser attached.

FIG. 6 is a perspective view of the invention with the removable paint applicator attached.

FIG. 7 is a front perspective view of a multi-level temperature-controlled storage cabinet used in conjunction with the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Referring to the drawings wherein the showings are for purposes of illustrating preferred embodiment of the present invention only, and that other forms and methods may be used to achieve the same effect for the purpose of this invention.

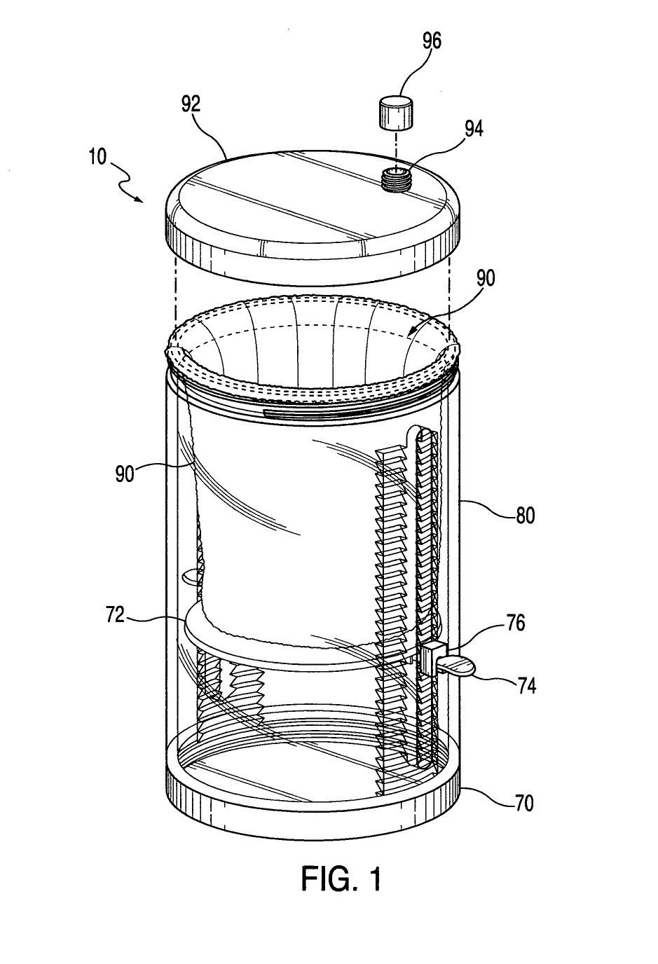

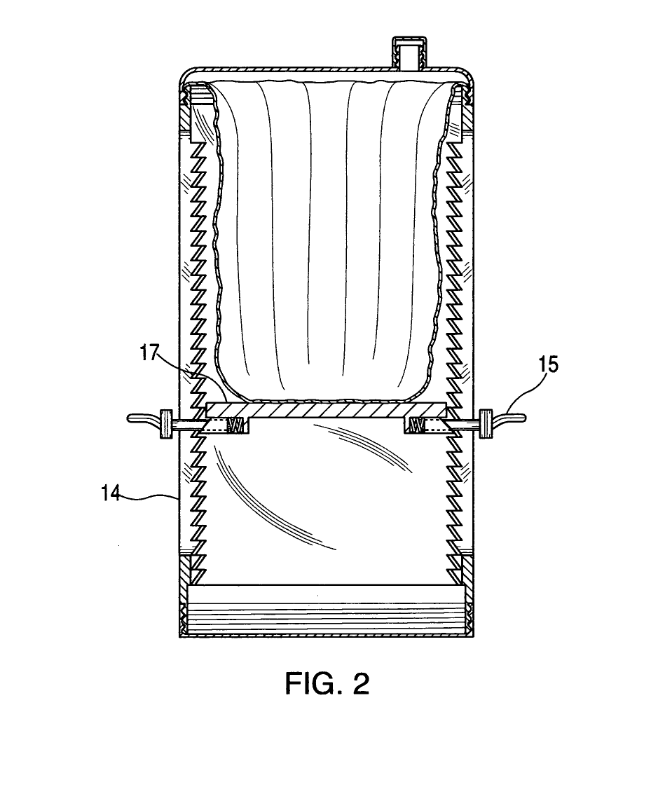

FIG. 1 and FIG. 2 show perspective views of apparatus for retarding oxidation of paint stored in a partly filled container, according to the preferred embodiment of the present invention.

Referring to FIG. 1 and FIG. 2, said apparatus comprises a body 80, constructed of clear glass, clear plastic or any other appropriate type of material, with said body 80 having an open upper end and an orifice 90, and a lower end 70. The adjustable container includes a flexible liner 90 having an open end, with said liner 90 suspended in the open upper end 90, forming a recipient within the body 80 for holding the stored paint therein. The adjustable container includes an attachable lid 92 secured to the open upper end of the body 80 and is in communication with the open upper end of the flexible liner 90. The lid 92 also includes a filler port 94 for receiving the liquid therein. The filler port 94 further serves as an outlet for expelling excess air and also for dispensing paint out of the container. The lid 92 also contains a filler cap 96 used to close the filler port 94, thereby preventing the flow of paint out of the apparatus 10 and also blocking the movement of air in and out of said apparatus.

A movable bottom plate 72 is provided that includes a lockable handle 74 or means to lock the movable bottom plate 72 and means to adjust said movable bottom plate up and down inside the body 80. Said movable bottom plate is guided by vertical groove 86 in the wall or sides of said body 80, keeping said bottom plate level while being pushed up and down. The movement of said movable bottom plate 72 results in changing the volume of the container. The handle 74 contains a lockable mechanism 76 or means of securing the movable bottom plate in the desired position after expelling excess air out of the container.

In use, the flexible liner 90 is inserted into the body 80 and secured by the lid 92 on orifice 90. The bottom plate 72 is moved to the lower part of the body 80, using the handle 74, thereby ensuring that flexible liner 90 is fully extended. The paint is then poured into the opening of the filler port 94, which fills the recipient formed by the flexible liner 90. The movable bottom plate 72 is then moved upwards so that the level of the paint reaches the top of the filler port 94 without overflowing, thereby expelling all excess air out of the container liner 90. The lockable handle 74 is then locked into the desired position and the filler cap 96 is closed, thereby ensuring that no paint can escape the container and no air can enter into the liner through the filler port. Using said apparatus 10 results in reduction of oxidation by storing the paint in an air-free environment.

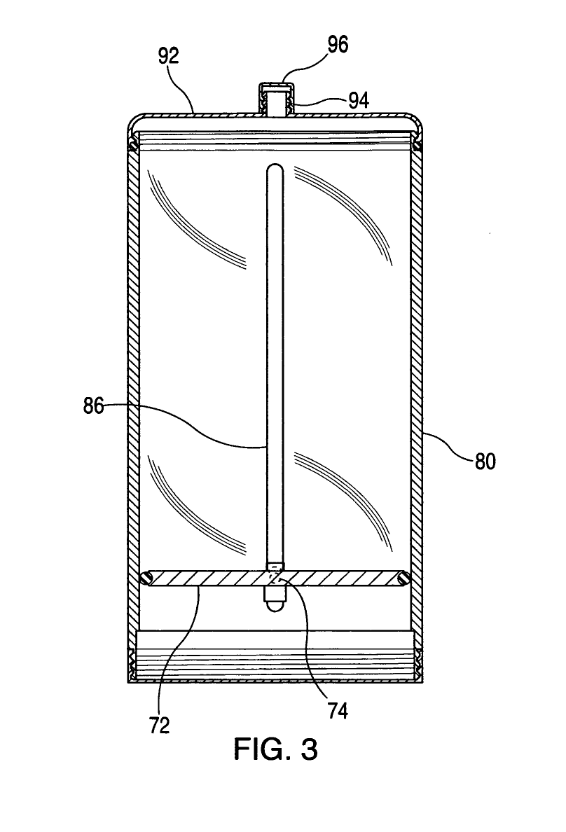

Referring now to FIG. 3, a perspective view of yet another embodiment of the present invention is disclosed. In this embodiment, the flexible liner 90 is omitted. The attachable lid 92 contains a sealing element 98 that sits on orifice 90, forming a seal between said lid and the upper end of apparatus body 80. Similarly, the movable bottom plate contains a radially extending sealing element so as to form a seal between the movable bottom plate and the wall of the apparatus body 80. The paint is then poured directly into the apparatus body 80, via the open filler port 94 on the lid 92.

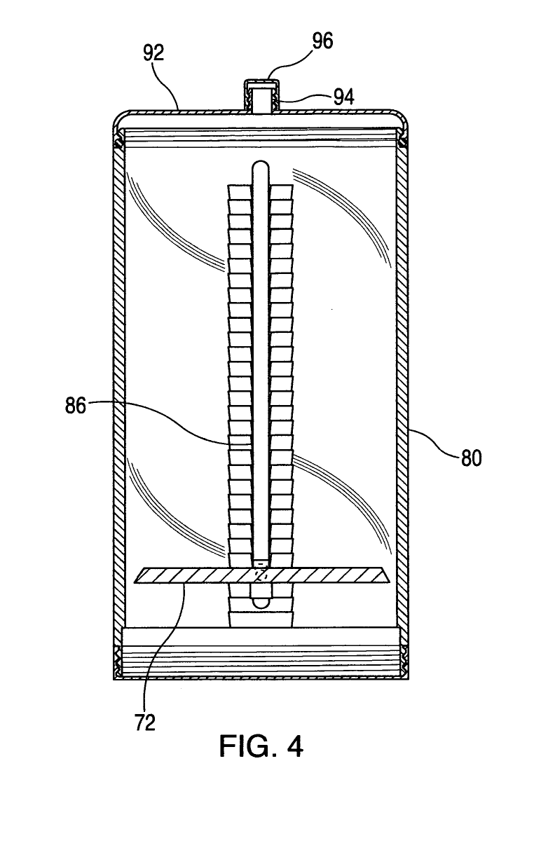

Referring now to FIG. 4, a side view of apparatus 10, showing vertical groove 86 in body 80. Said vertical groove 86 is used to guide the movable bottom plate 72 while traveling up and down inside of the body 80.

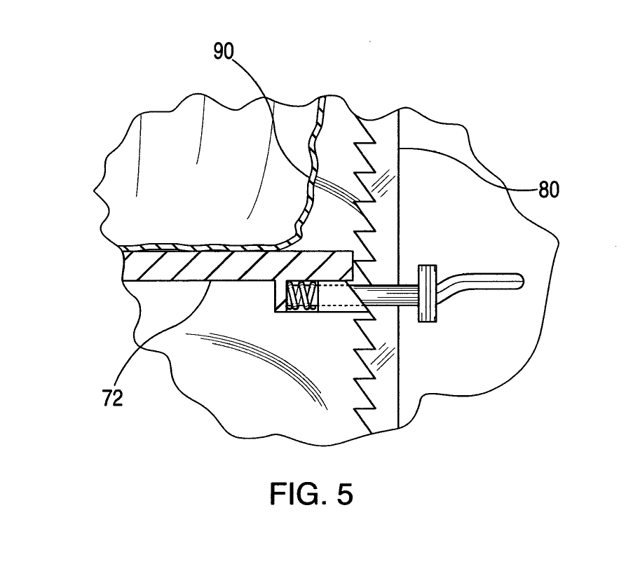

FIG. 5 represents a cross-sectional section view of the movable bottom plate 72, along with the handle 74 or means to move the bottom plate, the locking mechanism 76 or means to lock said bottom plate, and the flexible liner 90, according to the preferred embodiment of the present invention.

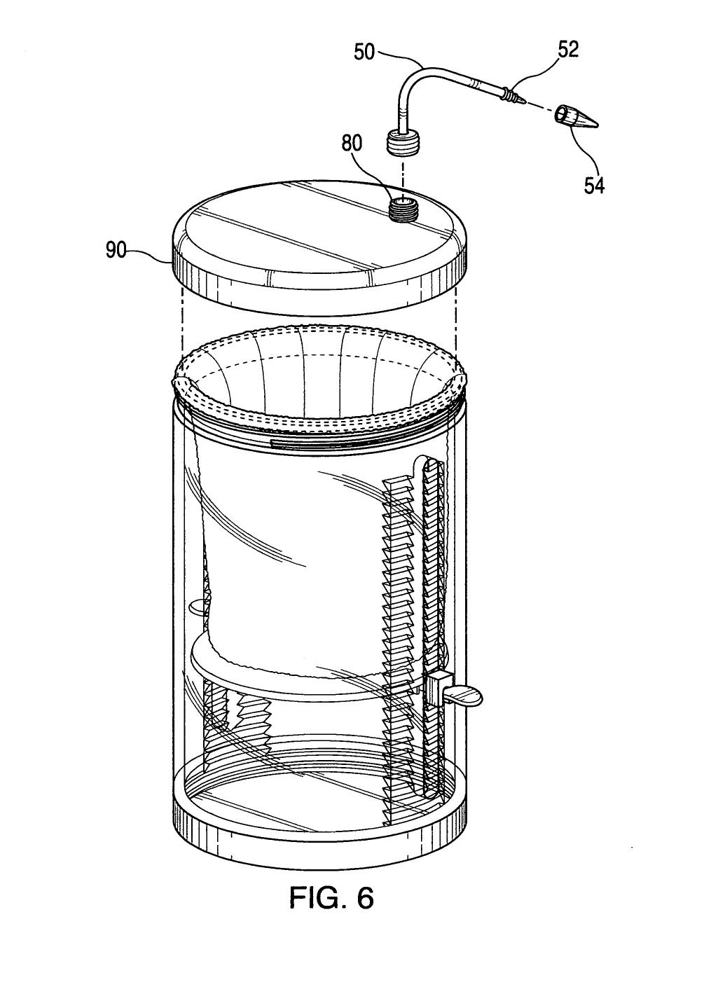

Referring now to FIG. 6, a perspective view of apparatus 10, with the addition of the removable paint dispensing apparatus 50, according to the preferred embodiment of the present invention, is disclosed. In use, the filler cap 96 is removed and replaced with the removable dispensing apparatus 50, comprising a dispensing tube 52, through which the paint flows out of apparatus 10. The paint is then dispensed through the nozzle 54, having a nozzle cap 56.

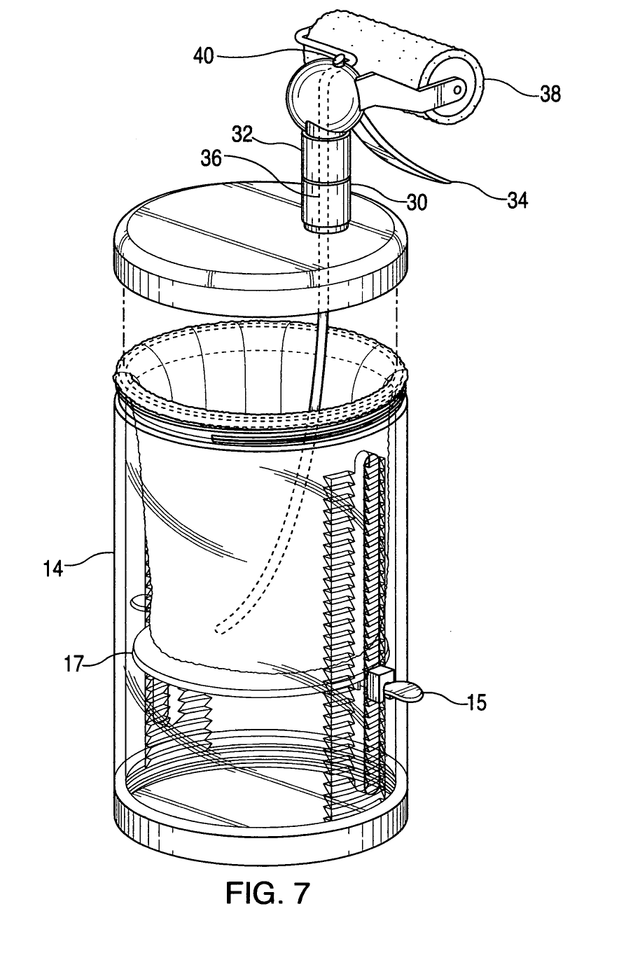

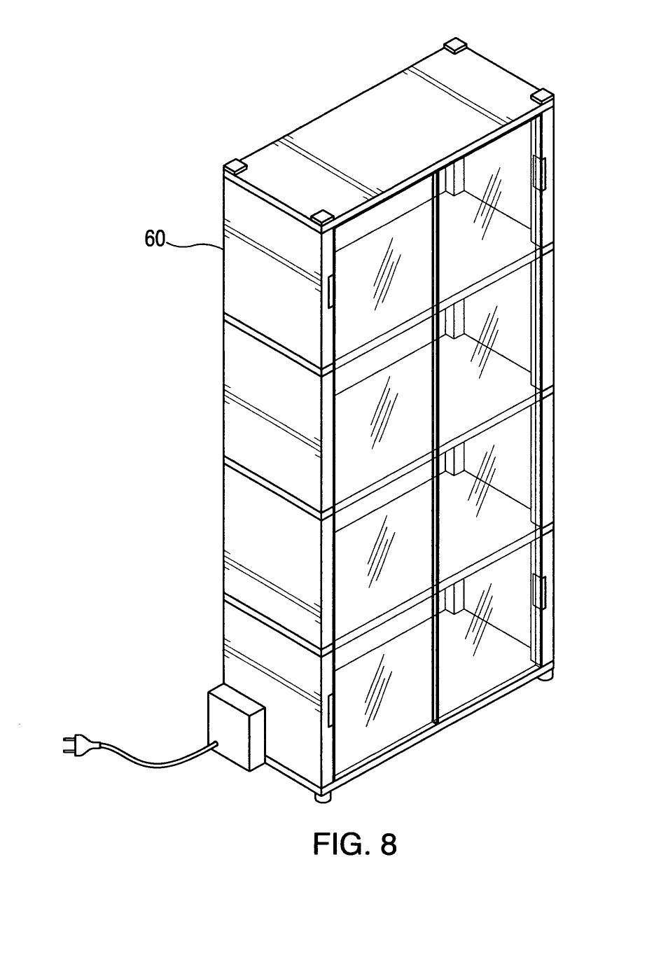

Referring now to FIG. 7, a perspective view of apparatus 10, with the addition of the removable paint applicator apparatus 30, according to the preferred embodiment of the present invention, is disclosed. In use, the filler cap 96 is removed and replaced with the removable paint applicator apparatus 30. Detailed discussion of the removable paint applicator apparatus 30 is omitted and deferred for disclosure in separate patent.

Referring now to FIG. 8, a perspective front view the multi-level temperature-controlled storage cabinet 60 used in conjunction with the present invention. Said storage cabinet 60 is able to store different sizes of containers in a compact space while greatly increasing the shelf life of the stored paint. Detailed discussion of the storage cabinet 60 is omitted and deferred for disclosure in separate patent.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Apparatus for retarding oxidation of liquid stored in a partially filled container comprising, in combination:
a body with an open upper end, and a lower end;
a flexible liner, open at one end, said liner open end suspended on said upper end of said body, forming a recipient within said body;
a lid, attachable to the body upper end, with a filler port and a removable filler cap;
a movable bottom with means of locking said movable bottom into a desired position, further means to adjust the movable bottom up and down in the container, thereby changing the volume of the flexible liner, resulting in expelling all excess air out of the partially filled liner, through the open filler port.

2. The container of claim 1, wherein the wall of the body includes vertical grooves with means to guide the movable bottom plate and keep said bottom plate aligned and leveled during up and down movement;

3. The container of claim 1, wherein the filler port is attached to a removable paint dispensing attachment, comprising a flexible tube and a dispensing nozzle, through which stored paint is dispensed out of the container when the movable bottom is pushed up toward the upper end of the container.

4. The container of claim 1, wherein the filler port is attached to a removable paint applicator attachment, further disclosed in a separate related patent.

5. The container of claim 1, characterized further in that said apparatus is made in different sizes, thereby providing means to accommodate different volume of leftover paint and store said different sized containers in a compact space.

6. The container of claim 1, wherein said apparatus is made of different types or combination of types of material, including and not limited to glass, plastic, metal, or any other physical substance deemed appropriate for the construction of said apparatus.

7. Apparatus for retarding oxidation of paint stored in a partially filled container comprising, in combination:
a body with an open upper end, and a lower end;
a lid with a peripheral sealing element, attachable to the body upper end, with a filler port and removable filler cap;
a movable bottom containing, in combination:
a radially extending sealing element so as to form a seal between the movable bottom and the inner walls of the body,
a means to lock and vertically adjust said movable bottom in the container thereby changing the volume of the container and further resulting in expelling all excess air out of the partially filled container through the open filler port.

8. A method of retarding oxidation of paint that only partly fills a container formed with a body, a flexible liner, a lid with an opening and a movable bottom, said method comprising the steps of:
inserting the flexible liner into the body of said container, mounting an attachable lid with a filler orifice and removable cap, positioning a movable bottom plate to the lower part of said body, using a handle means to move said bottom plate up and down; pouring the paint into said container through the open filler port in said lid;
adjusting said movable bottom plate upwards so that all excess air in said container is expelled out of the container through the open filler port in said lid;
locking said handle in the movable bottom plate and closing the filler port in said lid, thereby preventing air from entering the container and allowing the paint or liquid to be stored in an air-free environment, thereby retarding oxidation of the stored paint and increasing its shelf life.
